(19) United States
(12) Patent Application Publication
(10) Pub. No.: US 2007/0000110 A1
(43) Pub. Date: Jan. 4, 2007

(54) Method for treating PZT element, PZT micro-actuator, head gimbal assembly and disk drive unit with treated PZT micro-actuator

(75) Inventor: MingGao Yao, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/169,019

(22) Filed: Jun. 29, 2005

(51) Int. Cl. H04R 17/00

(52) U.S. Cl. 29/25.35; 29/25.42; 29/603.03; 29/603.08; 360/322; 360/294.4; 310/311

(57) ABSTRACT

A method for manufacturing a head gimbal assembly incorporating a PZT micro-actuator includes providing a PZT element, mounting the PZT element to a micro-actuator to provide a PZT micro-actuator, mounting a slider to the PZT micro-actuator to provide a slider and PZT micro-actuator assembly, mounting the slider and PZT micro-actuator assembly to a head gimbal assembly, electrically connecting the slider and PZT micro-actuator assembly to the head gimbal assembly, and treating the PZT element.

### FIELD OF THE INVENTION

The present invention relates to information recording disk drive units and, more particularly, to a method for treating a PZT element, a PZT micro-actuator, as well as a head gimbal assembly (HGA) and disk drive unit incorporating the treated PZT micro-actuator. More specifically, the present invention is directed to a PZT element of a micro-actuator for an HGA that is treated to improve stability of the PZT micro-actuator during use.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate a micro-actuator are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion or contraction thereof. The PZT micro-actuator is configured such that expansion or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803, entitled “Micro-actuator and HGA” and JP 2002-074871, entitled “Head Gimbal Assembly Equipped with Actuator for Fine Position, Disk Drive Equipped with Head Gimbals Assembly, and Manufacture Method for Head Gimbal Assembly.”

FIGS. 1a and 1b illustrate a conventional disk drive unit and show a magnetic disk 101 mounted on a spindle motor 102 for spinning the disk 101. A voice coil motor arm 104 carries a head gimbal assembly (HGA) 100 that includes a micro-actuator 105 with a slider 103 incorporating a read/write head. A voice-coil motor (VCM) 115 is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103, incorporating the read/write head, and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

FIG. 1c illustrates the head gimbal assembly (HGA) 100 of the conventional disk drive device of FIGS. 1a-1b incorporating a dual-stage actuator. However, because of the inherent tolerances of the VCM and the head suspension assembly, the slider 103 cannot achieve quick and fine position control which adversely impacts the ability of the read/write head to accurately read data from and write data to the disk. As a result, a PZT micro-actuator 105, as described above, is provided in order to improve the positional control of the slider and the read/write head. More particularly, the PZT micro-actuator 105 corrects the displacement of the slider 103 on a much smaller scale, as compared to the VCM, in order to compensate for the resonance tolerance of the VCM and/or head suspension assembly. The micro-actuator 105 enables, for example, the use of a smaller recording track pitch, and can increase the “tracks-per-inch” (TPI) value by 50% for the disk drive unit, as well as provide an advantageous reduction in the head seeking and settling time. Thus, the PZT micro-actuator 105 enables the disk drive device to have a significant increase in the surface recording density of the information storage disks used therein.

Referring more particularly to FIGS. 1c and 1d, a conventional PZT micro-actuator 105 includes a ceramic U-shaped frame which has two ceramic beams or side arms 107 each having a PZT element thereon. The ceramic beams 107 hold the slider 103 therebetween and displace the slider 103 by movement of the ceramic beams 107. The PZT micro-actuator 105 is physically coupled to a flexure 114 of suspension 113. Three electrical connection balls 109 (gold ball bonding or solder ball bonding, GBB or SBB) are provided to couple the micro-actuator 105 to the suspension traces 110 located at the side of each of the ceramic beams 107. In addition, there are four metal balls 108 (GBB or SBB) for coupling the slider 103 to the traces 110.

FIG. 1e generally shows an exemplary process for assembling the slider 103 with the micro-actuator 105. As illustrated, the slider 103 is partially bonded with the two ceramic beams 107 at two predetermined positions 106 (also see FIG. 1c) by epoxy 112. This bonding makes the movement of the slider 103 dependent on the movement of the ceramic beams 107 of the micro-actuator 105. A PZT element 116 is attached on each of the ceramic beams 107 of the micro-actuator to enable controlled movement of the slider 103 through excitation of the PZT elements 116. More particularly, when power is supplied through the suspension traces 110, the PZT elements 116 expand or contract to cause the two ceramic beams 107 of the U-shape micro-actuator frame to deform, thereby making the slider 103 move on the track of the disk in order to fine tune the position of the read/write head. In this manner, controlled displacement of slider 103 can be achieved for fine positional tuning. FIG. 1f illustrates the PZT micro-actuator 105 and slider 103 after being assembled as shown in FIG. 1e.

While the PZT micro-actuator described above provides an effective and reliable solution for fine tuning the position of the slider, it also includes certain drawbacks. More particularly, traditional PZT elements go through an annealing process during manufacture, which will refresh the piezoelectric characteristics of the PZT elements. Due to unforeseen reasons in the manufacturing process or the transfer process (e.g., the temperature above the PZT curie temperature, the driver voltage out of control, etc.), the characteristics of each PZT element change or its crystal structure undergoes a phase change from a non-symmetric lattice (piezoelectric) to a symmetrical lattice (non-piezoelectric). This change will cause the PZT element to lose properties or di-polarize the properties and change the characteristics. For example, this change causes a drastic dielectric and piezoelectric coefficient change (e.g., elastic, dielectric and piezoelectric coupling coefficient), which results in unstable characteristics of the PZT element during use. For example, the capacitance, resonance, frequency response, and/or displacement of the PZT element may be unstable or degenerate during use.

To keep the disk drive device substantially stable and reliable during use (especially in a high density recording disk unit with the TPI value increasing), stability and reliability of the PZT micro-actuator during use is very important. If the PZT micro-actuator is unstable or unreliable during use wherein working conditions (e.g., temperature or humidity) may change, the instability and unreliability may cause read/write errors and cause the disk drive device to work inefficiently or damage the disk drive device.

Thus, there is a need for an improved PZT micro-actuator for use in head gimbal assemblies and disk drive units that does not suffer from the above-mentioned stability and/or reliability problems, yet still enables fine tuning of the read/write head.

### SUMMARY OF THE INVENTION

One aspect of the present invention relates to a method for treating the PZT element of the micro-actuator for a head gimbal assembly to optimize and refresh the PZT characteristics and improve its stability and reliability.

Another aspect of the present invention is to provide a micro-actuator that includes a treated PZT element.

Another aspect of the present invention is to provide a head gimbal assembly that includes a treated PZT micro-actuator to enable fine head position adjustments and provide improved stability and reliability characteristics.

Another aspect of the present invention is to provide a disk drive unit with a large servo bandwidth and storage capacity, as well as fine head position adjustment using a treated PZT micro-actuator.

Another aspect of the invention relates to a method for manufacturing a head gimbal assembly incorporating a PZT micro-actuator. The method includes providing a PZT element, mounting the PZT element to a micro-actuator to provide a PZT micro-actuator, mounting a slider to the PZT micro-actuator to provide a slider and PZT micro-actuator assembly, mounting the slider and PZT micro-actuator assembly to a head gimbal assembly, electrically connecting the slider and PZT micro-actuator assembly to the head gimbal assembly, and treating the PZT element.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive unit;

FIG. 1b is a partial perspective view of the conventional disk drive unit shown in FIG. 1a;

FIG. 1c is a perspective view of a conventional head gimbal assembly (HGA);

FIG. 1d is an enlarged, partial perspective view of the HGA shown in FIG. 1c;

FIG. 1e illustrates a general process of inserting a slider into the micro-actuator of the HGA shown in FIG. 1c;

FIG. 1f illustrates an assembled micro-actuator and slider of the prior art;

FIG. 2 is a flow chart illustrating a manufacturing process according to an embodiment of the present invention;

FIGS. 3a-3e are sequential views illustrating the manufacturing process shown in FIG. 2;

FIG. 4a shows displacement distribution for a prior art micro-actuator;

FIG. 4b shows displacement distribution for the present invention;

FIG. 5a shows capacitance distribution for a prior art micro-actuator;

FIG. 5b shows capacitance distribution for the present invention;

FIG. 6a shows frequency response for a prior art micro-actuator;

FIG. 6b shows frequency response for the present invention;

FIG. 7 shows displacement results during high temperature and high humidity testing for a prior art micro-actuator and a micro-actuator according to the present invention;

FIG. 8 shows capacitance results during high temperature and high humidity testing for a prior art micro-actuator and a micro-actuator according to the present invention;

FIG. 9 shows displacement results during thermal shock testing for a prior art micro-actuator and a micro-actuator according to the present invention;

FIG. 10 shows capacitance results during thermal shock testing for a prior art micro-actuator and a micro-actuator according to the present invention;

FIG. 11 is a flow chart illustrating a manufacturing process according to another embodiment of the present invention;

FIGS. 12a-12e are sequential views illustrating the manufacturing process shown in FIG. 11;

FIG. 13 is a flow chart illustrating a manufacturing process according to still another embodiment of the present invention;

FIGS. 14a-14e are sequential views illustrating the manufacturing process shown in FIG. 13;

FIG. 15 is a flow chart illustrating a manufacturing process according to yet another embodiment of the present invention;

FIGS. 16a-16i are sequential views illustrating the manufacturing process shown in FIG. 15;

FIG. 17 is a perspective view of a box oven usable in the manufacturing process according to the present invention; and

FIG. 18 is a perspective view of a light source usable in the manufacturing process according to the present invention.

### DETAILED DESCRIPTION OF ILLUSTRATED EMBODIMENTS

Various preferred embodiments of the instant invention will now be described with reference to the figures, wherein like reference numerals designate similar parts throughout the various views. As indicated above, the instant invention is designed to improve the stability and reliability of a micro-actuator when the micro-actuator having a PZT element is excited for the purpose of fine tuning the position of the read/write head. An aspect of the instant invention is to provide a method for treating a PZT element of the micro-actuator to improve the stability and reliability of the PZT element of the micro-actuator during use. By improving the stability of the PZT element of the micro-actuator, the performance and reliability characteristics of the device are improved.

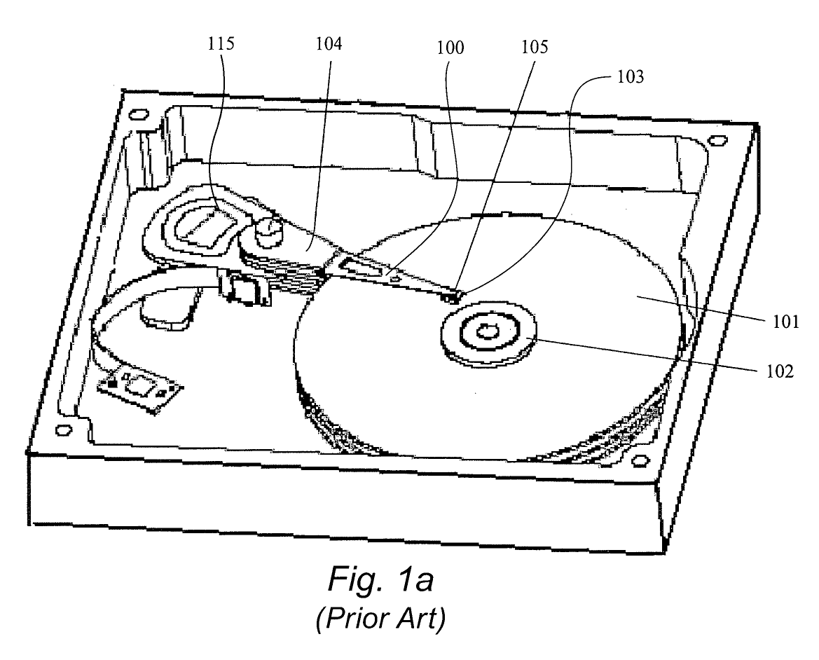

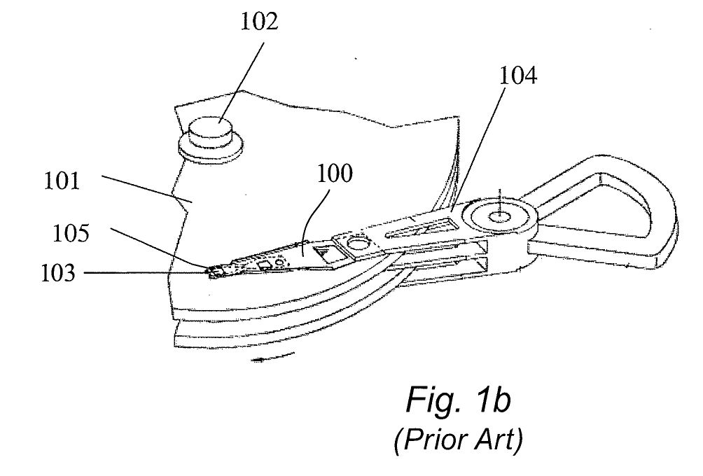

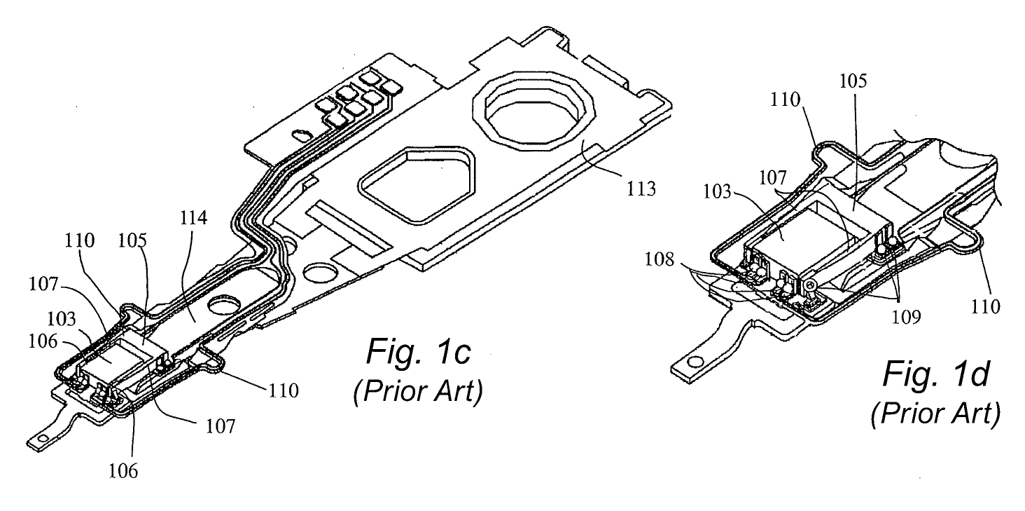

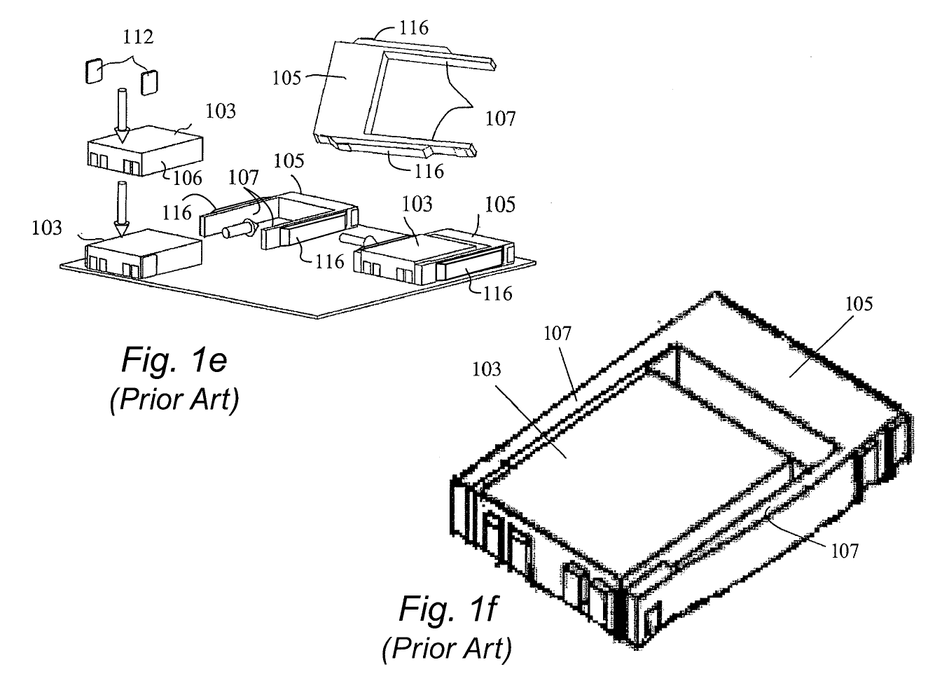

Several example embodiments of methods for treating a PZT element of the micro-actuator will now be described. Some of the example embodiments are illustrated in the figures and described as being implemented in a conventional head gimbal assembly (HGA) of the type described above in connection with FIGS. 1cand 1d. However, it is noted that the invention is not limited to such implementations. Instead, the methods for treating a PZT element of the micro-actuator can be. implemented in any suitable device having a PZT element or sensor or PZT micro-actuator in which it is desired to improve the stability characteristics, regardless of the specific structure of the PZT element device as illustrated in the figures. That is, the invention may be used in any suitable device having a PZT element in any industry.

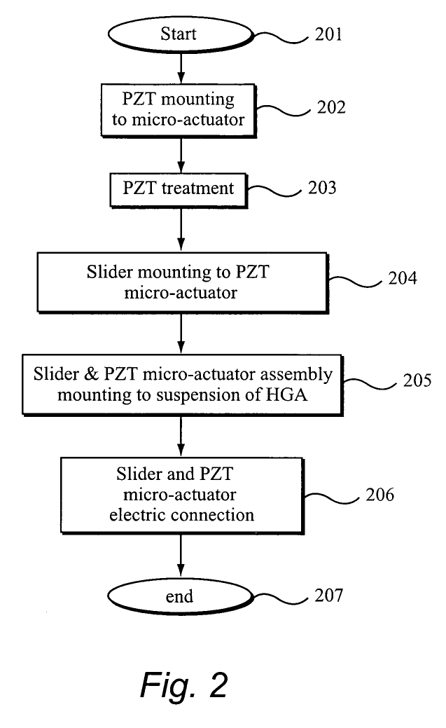

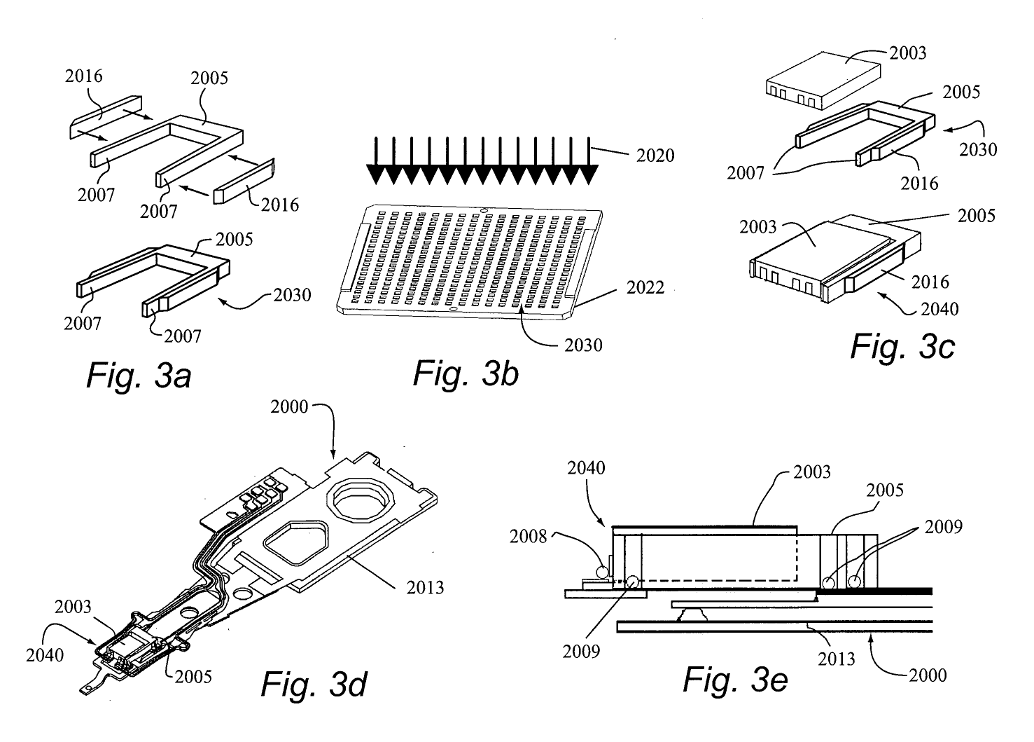

FIGS. 2 and 3a-3e illustrate the primary steps involved in the manufacturing and assembly process of a head gimbal assembly incorporating a treated PZT micro-actuator according to a first exemplary embodiment of the present invention. Specifically, after the process starts (step 201 of FIG. 2), at least one PZT element 2016 is mounted to a micro-actuator 2005 to provide a PZT micro-actuator 2030 (step 202 of FIG. 2), as shown in FIG. 3a.

In the illustrated embodiment, PZT elements 2016 are mounted to a micro-actuator 2005 of the type shown in FIGS. 1c-1f. As explained above, this type of micro-actuator includes a U-shaped frame which has two side arms 2007. A PZT element 2016 is mounted to each of the side arms 2007 of the micro-actuator 2005 to provide the PZT micro-actuator 2030. The PZT element 2016 is preferably a block of ceramic or thin film PZT. The PZT element 2016 may be either single layer or multi-layer PZT. It is noted that the micro-actuator 2005 may have other suitable structures and may be made from any suitable material, e.g., ceramic. Also, one or more PZT elements 2016 may be mounted to the micro-actuator 2005 in any suitable manner.

Next, as shown in FIG. 3b, the PZT micro-actuator 2030 is positioned on a tray 2022 structured to hold a plurality of PZT micro-actuators 2030, e.g., curing tray, and the tray 2022 is put into a device that provides a treatment process to treat the PZT micro-actuators 2030 (step 203 of FIG. 2). The treatment process is adapted to improve the stability and reliability of the PZT elements 2016 in use.

In the illustrated embodiment, the treatment process includes heat and/or light treatment 2020 of the PZT micro-actuators 2030 as shown in FIG. 3b. That is, the treatment process preferably includes exposing the PZT micro-actuators 2030 to a heat source and/or exposing the PZT micro-actuators 2030 to a light source. In an embodiment, the treatment process includes a curing process. During treatment, the temperature is preferably maintained within a range of ±25° C. of the PZT curie temperature. A tighter temperature range around the PZT curie temperature is even more preferable. Also, a 100-1000 mw/cm2 light waveform density is preferable for this treatment.

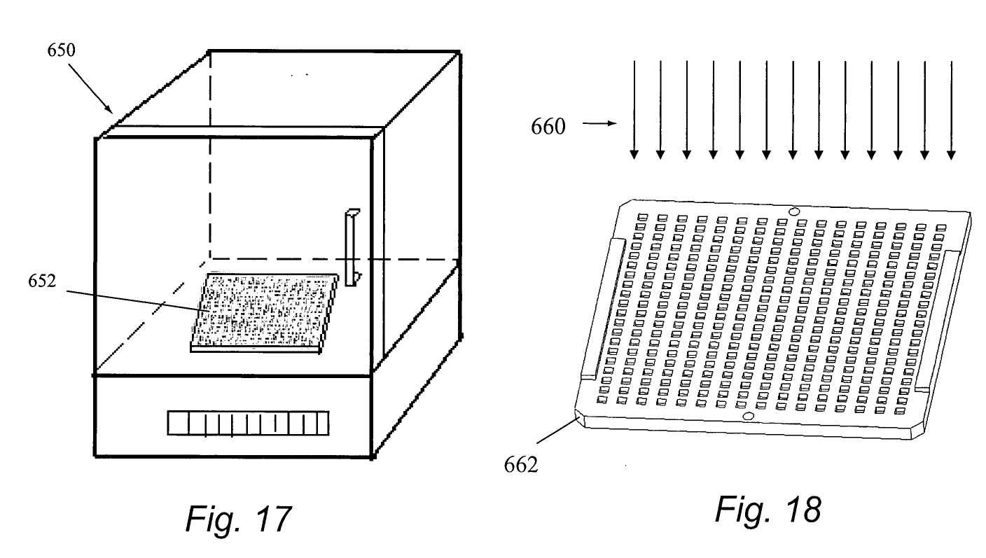

The heat treatment may be provided by a heat cycle, box oven (see FIG. 17), or a microwave oven, for example, and the light treatment may be provided by UV light or a normal light source (see FIG. 18), for example. The PZT micro-actuators 2030 may be exposed to the heat and/or light source for a pre-determined period amount of time. The characteristics of the heat and/or light source may vary during the treatment session, and the treatment session may include one or more sessions in which the PZT micro-actuators 2030 are exposed to the heat and/or light source for a period of time.

In an embodiment of this invention, energy, e.g., current/voltage, may be applied to the PZT element to initial the properties of the PZT material. The current/voltage is preferably at least 10% of the operation current or operation voltage. The application of energy may keep the treatment process more effective. In another embodiment of this invention, the treatment may include energy beam irradiation (e.g., ion beam, laser beam, electron beam, cluster beam, etc.) during the treatment process.

After the PZT micro-actuators 2030 are treated by the treatment process, a slider 2003 is mounted to each treated PZT micro-actuator 2030 to provide a slider and PZT micro-actuator assembly 2040 as shown in FIG. 3c (step 204 of FIG. 2). The slider 2003 may be mounted to the PZT micro-actuator 2030 as shown in FIGS. 1e-1f. As explained above, the slider 2003, incorporating the read/write head, is bonded between the side arms 2007 of the micro-actuator 2005 by epoxy. However, the slider 2003 may have other suitable structures and may be mounted to the PZT micro-actuator 2030 in any suitable manner.

Then, as shown in FIG. 3d, the slider and PZT micro-actuator assembly 2040 is mounted to a suspension 2013 of a head gimbal assembly 2000 (step 205 of FIG. 2). In an embodiment, the micro-actuator 2005 is partially bonded, e.g., using an epoxy, on a suspension tongue of the suspension 2013. However, the slider and PZT micro-actuator assembly 2040 may be mounted to the suspension 2013 in any suitable manner.

Next, as shown in FIG. 3e, the slider and PZT micro-actuator assembly 2040 is electrically connected to the suspension 2013 of the head gimbal assembly 2000 (step 206 of FIG. 2). As explained above in FIGS. 1c and 1d, three electrical connection balls 2009 (GBB or SBB) are provided to couple the micro-actuator 2005 to the suspension traces located at the side of each of the side arms. In addition, four electrical connection balls 2008 (GBB or SBB) are provided to couple the slider 2003 to the suspension traces. This completes the manufacturing and assembly process of the head gimbal assembly 2000 according to the first exemplary embodiment (step 207 of FIG. 2).

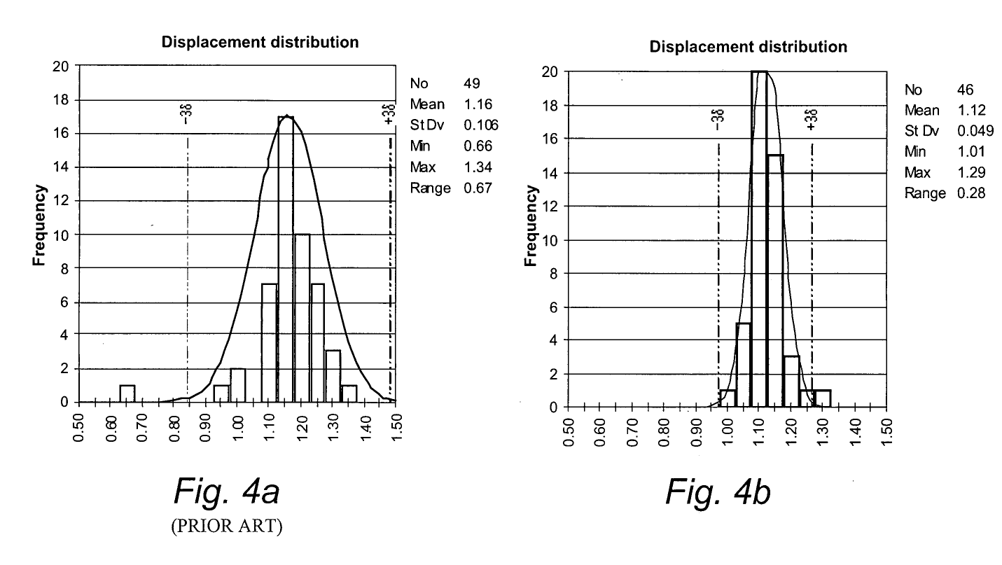

The head gimbal assembly 2000 incorporating a treated PZT element micro-actuator 2030 has several advantages. For example, FIG. 4a illustrates the displacement distribution for a prior art micro-actuator and FIG. 4b illustrates the displacement distribution for the treated PZT element micro-actuator 2030 manufactured according to the present invention. As illustrated, the distribution sigma or standard deviation in displacement for the treated PZT micro-actuator 2030 is smaller, e.g., about 50% smaller, than the sigma or standard deviation in displacement for the prior art micro-actuator. The smaller distribution sigma or standard deviation in displacement of the treated PZT element micro-actuator 2030 results in more stability and reliability of the PZT micro-actuator 2030 in use.

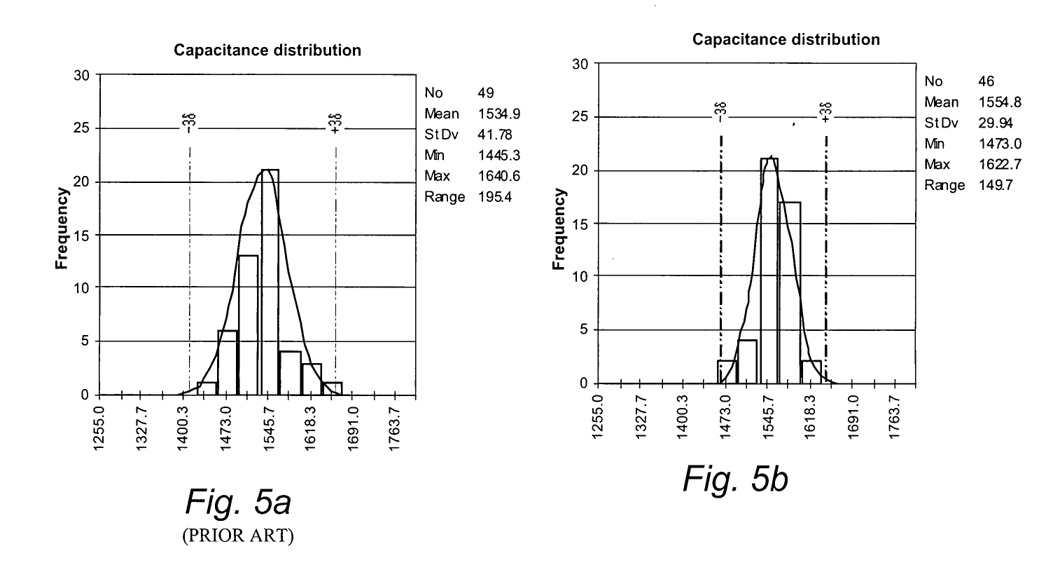

FIG. 5a illustrates the capacitance distribution for a prior art micro-actuator and FIG. 5b illustrates the capacitance distribution for the treated PZT micro-actuator 2030 manufactured according to the present invention. As illustrated, the distribution sigma or standard deviation in capacitance for the treated PZT micro-actuator 2030 is smaller than the sigma or standard deviation in capacitance for the prior art micro-actuator. The smaller distribution sigma or standard deviation in capacitance of the treated PZT micro-actuator 2030 results in more stability and reliability of the PZT micro-actuator 2030 in use.

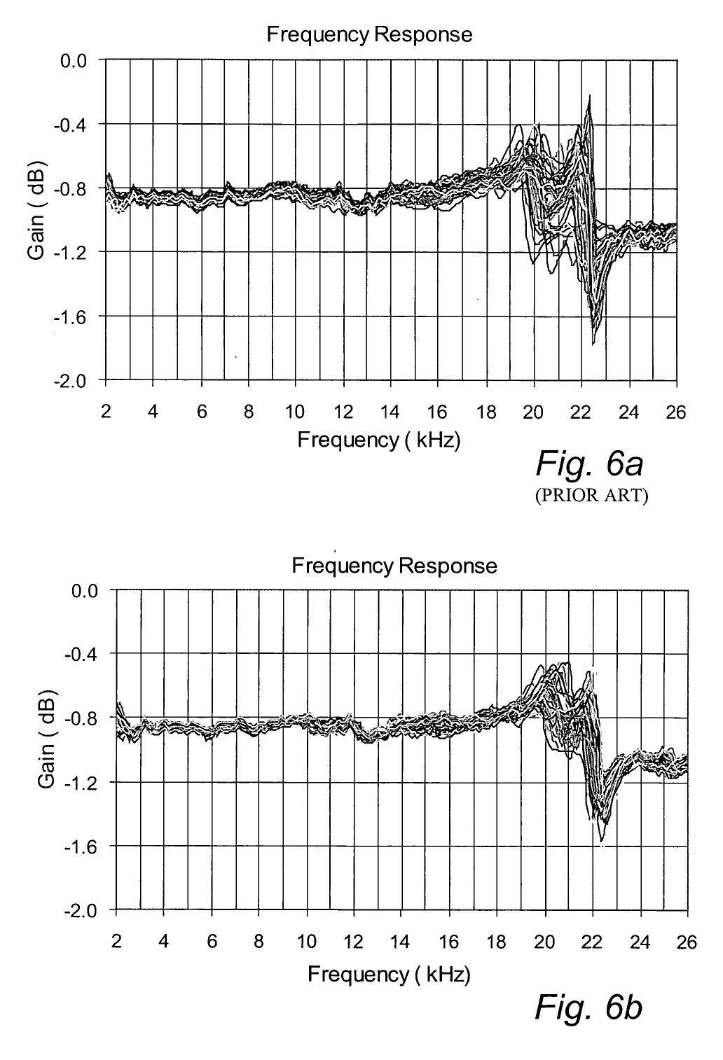

FIG. 6a illustrates the frequency response for a prior art micro-actuator and FIG. 6b illustrates the frequency response for the treated PZT micro-actuator 2030 manufactured according to the present invention. As illustrated, the frequency response for the treated PZT micro-actuator 2030 is more stable than the prior art micro-actuator.

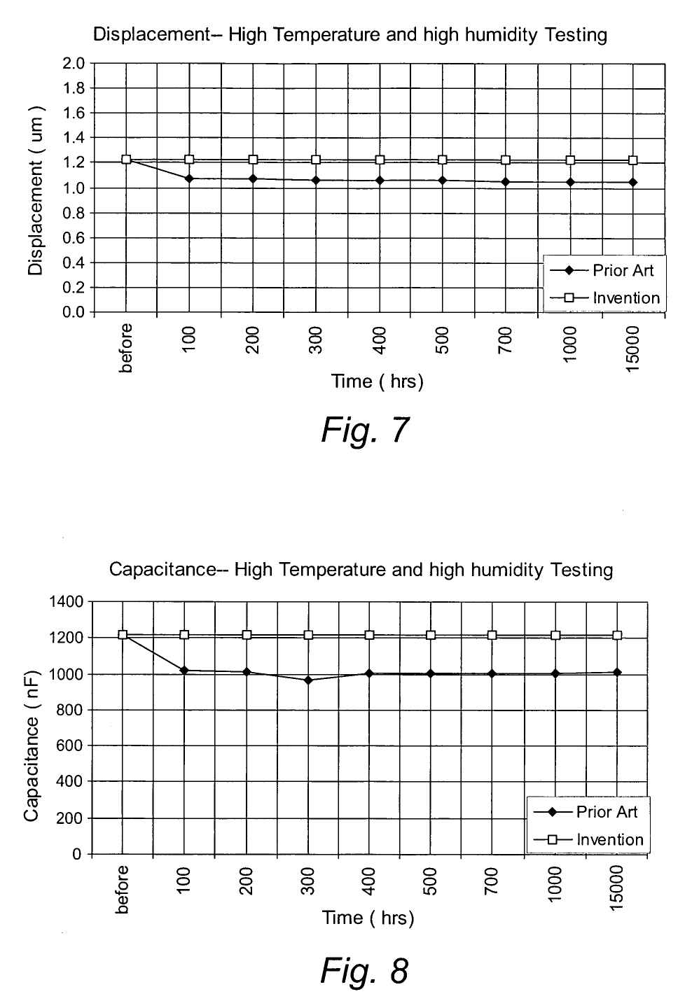

FIG. 7 illustrates the displacement results during high temperature and high humidity testing for a prior art PZT micro-actuator and the treated PZT micro-actuator 2030 manufactured according to the present invention. As illustrated, the displacement trend for the treated PZT micro-actuator 2030 is more stable and reliable than the prior art micro-actuator.

FIG. 8 illustrates the capacitance results during high temperature and high humidity testing for a prior art PZT micro-actuator and the treated PZT micro-actuator 2030 manufactured according to the present invention. As illustrated, the capacitance trend for the treated PZT micro-actuator 2030 is more stable and reliable than the prior art micro-actuator.

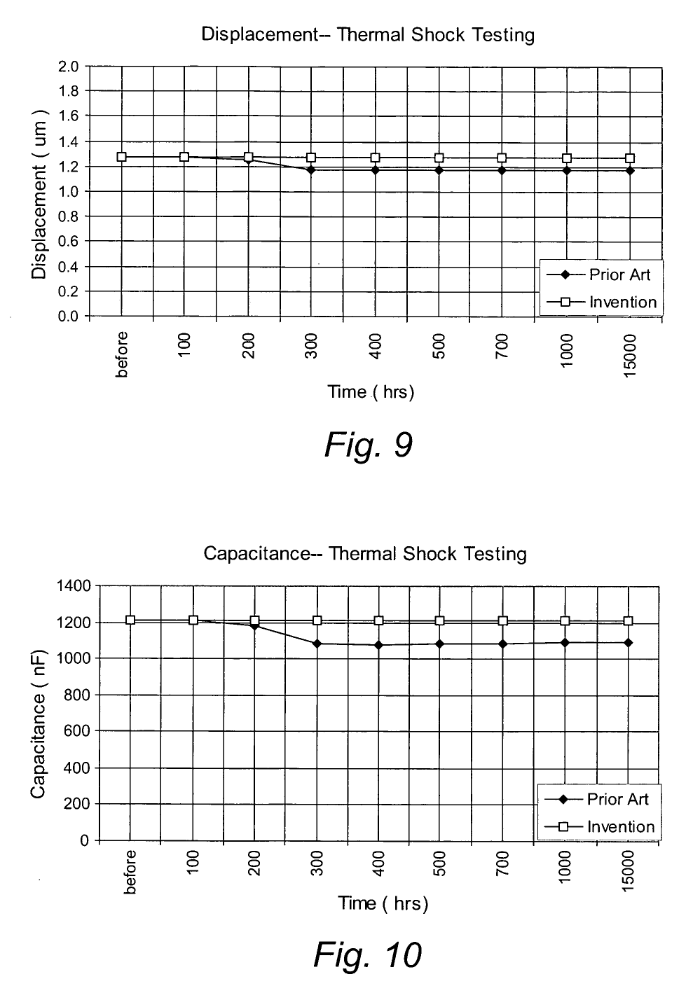

FIG. 9 illustrates the displacement results during thermal shock testing for a prior art PZT micro-actuator and the treated PZT micro-actuator 2030 manufactured according to the present invention. As illustrated, the displacement trend for the treated PZT micro-actuator 2030 is more stable and reliable than the prior art micro-actuator.

FIG. 10 illustrates the capacitance results during thermal shock testing for a prior art PZT micro-actuator and the treated PZT micro-actuator 2030 manufactured according to the present invention. As illustrated, the capacitance trend for the treated PZT micro-actuator 2030 is more stable and reliable than the prior art micro-actuator.

It is noted that treatment of the PZT micro-actuator may occur during one or more stages of assembly of the head gimbal assembly. Specifically, the treatment of the PZT micro-actuator may occur during one or more stages of assembly of the PZT micro-actuator itself and/or during one or more stages of assembly for incorporating the PZT micro-actuator into the head gimbal assembly. Also, an energy source, e.g., current/voltage may be applied to the PZT element/device during the treatment process. The current/voltage is at least 10% of the operation current or operation voltage. Further, the treatment may include energy beam irradiation, e.g., ion beam, laser beam, electron beam, cluster beam, etc., during the treatment process.

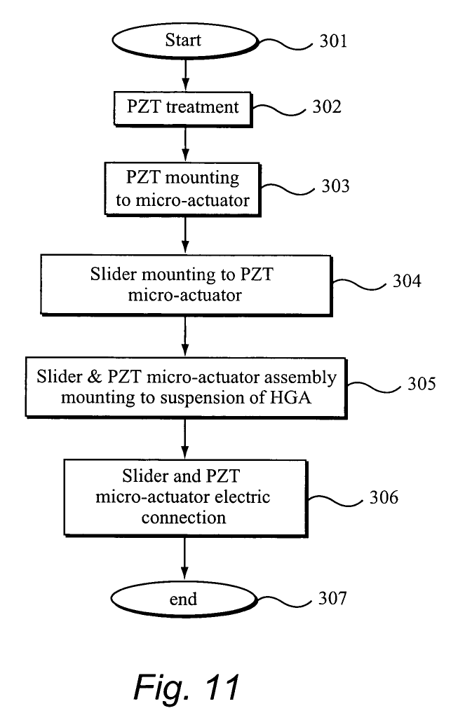

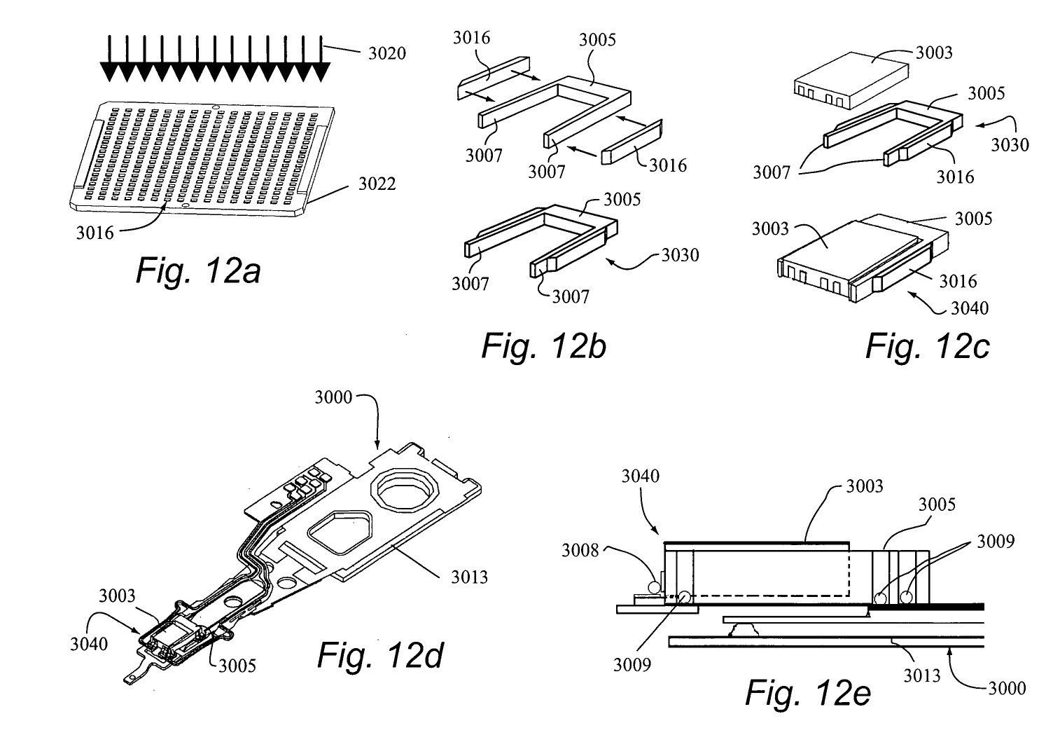

For example, FIGS. 11 and 12a-12e illustrate the primary steps involved in the manufacturing and assembly process of a head gimbal assembly incorporating a treated PZT micro-actuator according to a second exemplary embodiment of the present invention. In this embodiment, the PZT elements are treated prior to mounting the PZT elements to the micro-actuator. Also, an energy source, e.g., current/voltage may be applied to the PZT element/device during the treatment process. The current/voltage is at least 10% of the operation current or operation voltage. Further, the treatment may include energy beam irradiation, e.g., ion beam, laser beam, electron beam, cluster beam, etc., during the treatment process.

Specifically, after the process starts (step 301 of FIG. 11), a plurality of PZT elements 3016 are positioned on a tray 3022 structured to hold the plurality of PZT elements 3016, e.g., curing tray. As shown in FIG. 12a, the tray 3022 is put into a device that provides a treatment process to treat the PZT elements 3016 (step 302 of FIG. 11). As explained above, the treatment process includes heat and/or light treatment 3020 to improve the stability and reliability of the PZT elements 3016 in use.

After the PZT elements 3016 are treated by the treatment process, treated PZT elements 3016 are mounted to side arms 3007 of a micro-actuator 3005 to provide a PZT micro-actuator 3030 (step 303 of FIG. 11), as explained above and shown in FIG. 12b. Then, as explained above and shown in FIG. 12c, a slider 3003 is mounted to the PZT micro-actuator 3030 to provide a slider and PZT micro-actuator assembly 3040 (step 304 of FIG. 11). Next, as explained above and shown in FIG. 12d, the slider and PZT micro-actuator assembly 3040 is mounted to a suspension 3013 of a head gimbal assembly 3000 (step 305 of FIG. 11). Finally, the slider and PZT micro-actuator assembly 3040 is electrically connected to the suspension 3013 of the head gimbal assembly 3000 via connection balls 3008, 3009 (step 306 of FIG. 11), as explained above and shown in FIG. 12e. This completes the manufacturing and assembly process of the head gimbal assembly 3000 according to the second exemplary embodiment (step 307 of FIG. 11).

Similar to the first embodiment, the head gimbal assembly 3000 incorporating a treated PZT micro-actuator 3030 according to the second embodiment has several advantages, e.g., smaller distribution standard deviation in displacement and capacitance.

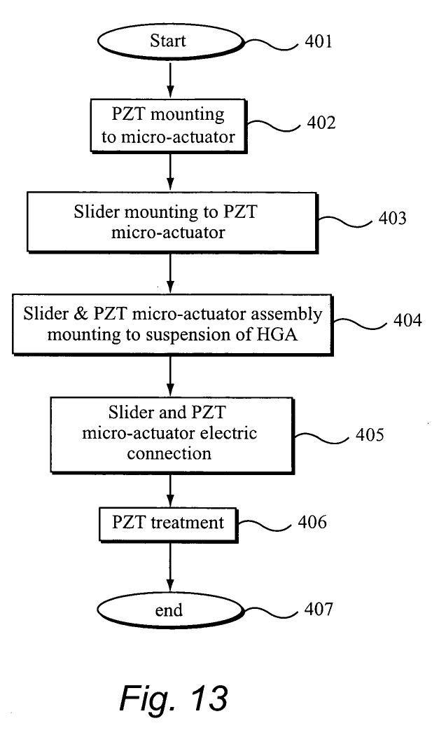

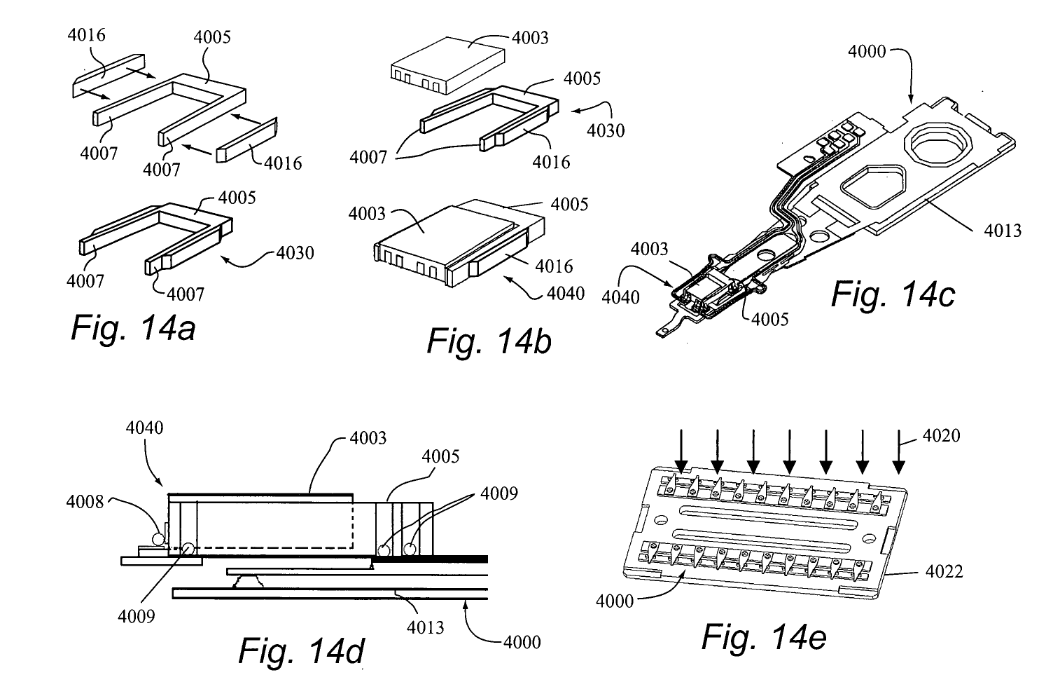

FIGS. 13 and 14a-14e illustrate the primary steps involved in the manufacturing and assembly process of a head gimbal assembly incorporating a treated PZT micro-actuator according to a third exemplary embodiment of the present invention. In this embodiment, the PZT micro-actuator is treated after the assembly process of the head gimbal assembly is completed. Also, an energy source, e.g., current/voltage may be applied to the PZT element/device during the treatment process. The current/voltage is at least 10% of the operation current or operation voltage. Further, the treatment may include energy beam irradiation, e.g., ion beam, laser beam, electron beam, cluster beam, etc., during the treatment process.

Specifically, after the process starts (step 401 of FIG. 13), PZT elements 4016 are mounted to side arms 4007 of a micro-actuator 4005 to provide a PZT micro-actuator 4030 (step 402 of FIG. 13), as explained above and shown in FIG. 14a. Then, as explained above and shown in FIG. 14b, a slider 4003 is mounted to the PZT micro-actuator 4030 to provide a slider and PZT micro-actuator assembly 4040 (step 403 of FIG. 13). Next, as explained above and shown in FIG. 14c, the slider and PZT micro-actuator assembly 4040 is mounted to a suspension 4013 of a head gimbal assembly 4000 (step 404 of FIG. 13). Subsequently, the slider and PZT micro-actuator assembly 4040 is electrically connected to the suspension 4013 of the head gimbal assembly 4000 via connection balls 4008, 4009 (step 405 of FIG. 13), as explained above and shown in FIG. 14d.

After the head gimbal assembly 4000 is assembled, a plurality of head gimbal assemblies 4000 incorporating PZT micro-actuators 4030 are positioned on a tray 4022 structured to hold the plurality of head gimbal assemblies 4000, e.g., curing tray. As shown in FIG. 14e, the tray 4022 is put into a device that provides a treatment process to treat the PZT micro-actuators 4030 (step 406 of FIG. 13). As explained above, the treatment process includes heat and/or light treatment 4020 to improve the stability and reliability of the PZT elements 4016 in use. This completes the manufacturing and assembly process of the head gimbal assembly 4000 according to the third exemplary embodiment (step 407 of FIG. 13).

Similar to the first and second embodiments, the head gimbal assembly 4000 incorporating a treated PZT micro-actuator 4030 according to the third embodiment has several advantages, e.g., smaller distribution standard deviation in displacement and capacitance.

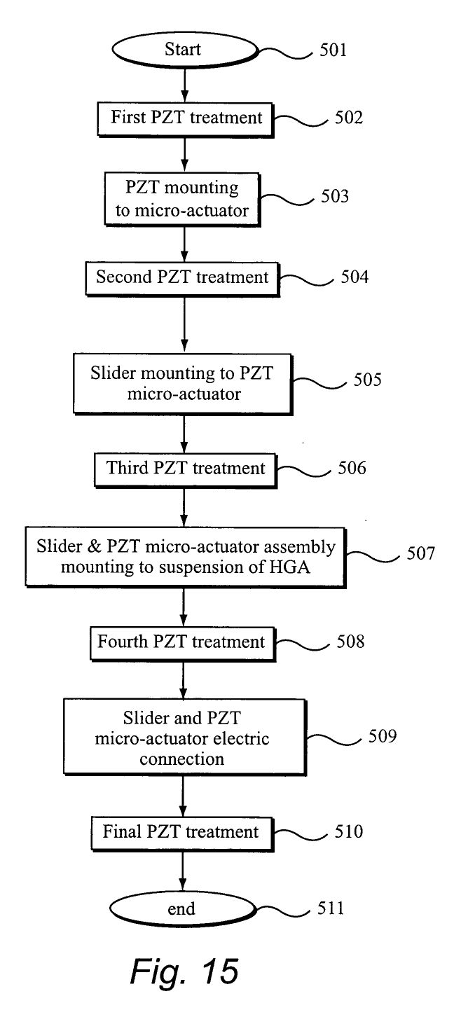

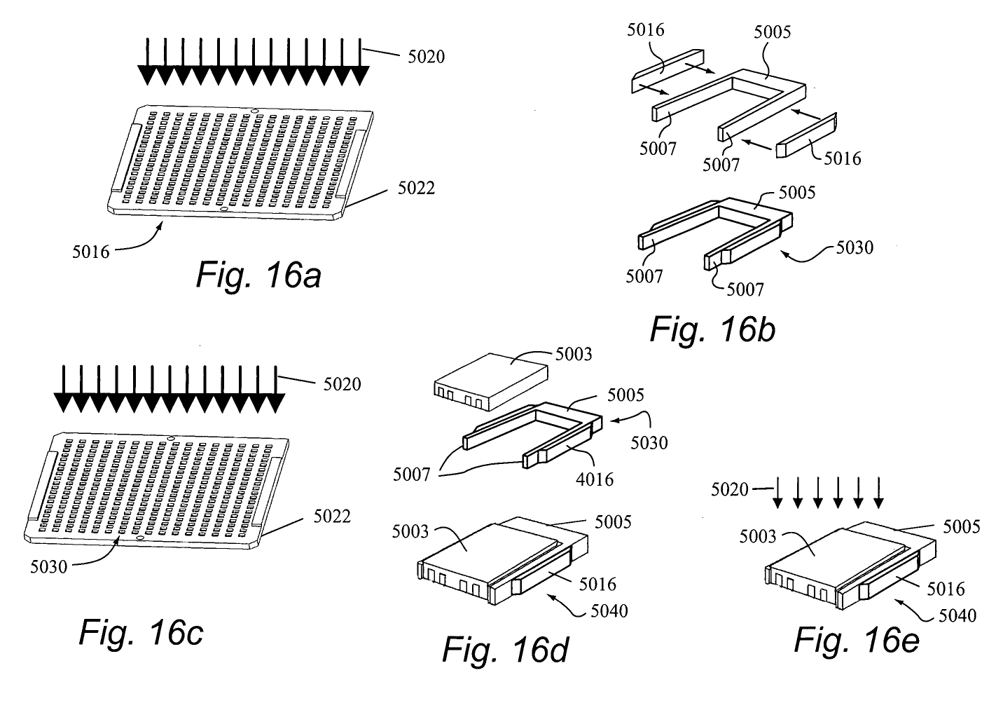

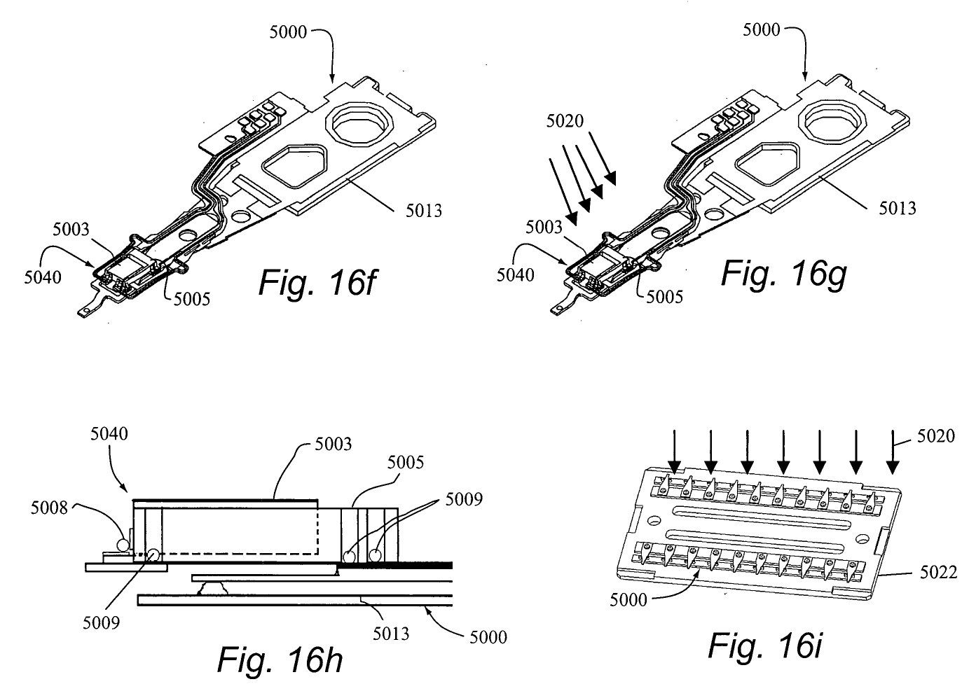

FIGS. 15 and 16a-16i illustrate the primary steps involved in the manufacturing and assembly process of a head gimbal assembly incorporating a treated PZT micro-actuator according to a fourth exemplary embodiment of the present invention. In this embodiment, the PZT micro-actuator is treated during stages of assembly of the PZT micro-actuator itself and during stages of assembly for incorporating the PZT micro-actuator into the head gimbal assembly.

Specifically, after the process starts (step 501 of FIG. 15), a plurality of PZT elements 5016 are positioned on a tray 5022 structured to hold the plurality of PZT elements 5016. As explained above and shown in FIG. 16a, the tray 5022 is put into a device that provides a treatment process, e.g., heat and/or light treatment 5020, to treat the PZT elements 5016 (step 502 of FIG. 15).

After the PZT elements 5016 are treated by the first treatment process, treated PZT elements 5016 are mounted to side arms 5007 of a micro-actuator 5005 to provide a PZT micro-actuator 5030 (step 503 of FIG. 15), as explained above and shown in FIG. 16b. Then, as explained above and shown in FIG. 16c, the PZT micro-actuator 5030 is positioned on a tray 5022 structured to hold a plurality of PZT micro-actuators 5030, and the tray 5022 is put into a device that provides a second treatment 5020 to treat the PZT micro-actuators 5030 (step 504 of FIG. 15).

After the PZT micro-actuators 5030 are treated by the second treatment, a slider 5003 is mounted to each treated PZT micro-actuator 5030 to provide a slider and PZT micro-actuator assembly 5040 (step 505 of FIG. 15), as explained above and shown in FIG. 16d. Then, the slider and PZT micro-actuator assembly 5040 is positioned on a tray 5022 structured to hold a plurality of slider and PZT micro-actuator assemblies 5040, and the tray 5022 is put into a device that provides a third treatment 5020 to treat the slider and PZT micro-actuator assemblies 5040 (step 506 of FIG. 15), as shown in FIG. 16e.

After the slider and PZT micro-actuator assemblies 5040 are treated by the third treatment, each treated slider and PZT micro-actuator assembly 5040 is mounted to a suspension 5030 of a head gimbal assembly 5000 (step 507 of FIG. 15), as explained above and shown in FIG. 16f. Then, the head gimbal assembly 5000 is positioned on a tray 5022 structured to hold a plurality of head gimbal assemblies 5000, and the tray 5022 is put into a device that provides a fourth treatment 5020 to treat the PZT micro-actuators 5030 of the head gimbal assemblies 5000 (step 508 of FIG. 15), as shown in FIG. 16g.

After the head gimbal assemblies 5000 are treated by the fourth treatment, the slider and PZT micro-actuator assembly 5040 of each head gimbal assembly 5000 is electrically connected to the suspension 5013 of the head gimbal assembly 5000 via connection balls 5008, 5009 (step 509 of FIG. 15), as explained above and shown in FIG. 16h. Finally, the head gimbal assembly 5000 is again positioned on a tray 5022 structured to hold a plurality of head gimbal assemblies 5000, and the tray 5022 is put into a device that provides a fifth and final treatment 5020 to treat the PZT micro-actuators 5030 of the head gimbal assemblies 5000 (step 510 of FIG. 15), as shown in FIG. 16i. This completes the manufacturing and assembly process of the head gimbal assembly 5000 according to the fourth exemplary embodiment (step 511 of FIG. 15).

Similar to the first, second, and third embodiments, the head gimbal assembly 5000 incorporating a treated PZT micro-actuator 5030 according to the fourth embodiment has several advantages, e.g., smaller distribution standard deviation in displacement and capacitance.

FIGS. 17 and 18 illustrate embodiments of the treatment process. For example, FIG. 17 illustrates a box oven 650 structured to provide heat treatment. A tray 652 including a plurality of PZT micro-actuators, for example, may be positioned within the box oven 650 to expose the PZT micro-actuators to the heat source provided by the box oven 650. FIG. 18 illustrates a tray 662 including a plurality of PZT micro-actuators, for example, receiving light treatment 660 from a light source, e.g., UV light.

The exemplary embodiments of the present invention described above provide a treatment process to improve the properties, e.g., stability, and reliability of a PZT micro-actuator. It is also noted that the treatment process is relatively simple and low cost, and the treatment process can be easily incorporated into prior PZT micro-actuator manufacturing processes. Additionally, the treatment process allows one to easily mass produce a plurality of treated PZT micro-actuators or other device with a PZT element.

Further, it is noted that a PZT element may be used in a variety of different ways to actuate a micro-actuator. The present invention covers any use of a PZT element on a micro-actuator or PZT device, and is not limited to the specific PZT configurations disclosed herein.

Also, the head gimbal assembly incorporating a treated PZT micro-actuator according to embodiments of the present invention may be incorporated in a disk drive unit of the type described above in connection with FIGS. 1a and 1b. Because the structure, operation and assembly processes of disk drive units are well known to persons of ordinary skill in the art, further details regarding the disk drive unit are not provided herein so as not to obscure the invention. The methods for treating a PZT element of the micro-actuator can be implemented in any suitable disk drive device having a PZT micro-actuator or any other device with a PZT element.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method for building a PZT material component into a product, the method comprising:
building a PZT material component into a product; and
conducting at least one activation treatment on the PZT material component before and/or after the PZT material component is built into the product.

2. The method according to claim 1, wherein the activation treatment includes an energy voltage/current, an energy beam irradiation treatment, and/or a temperature treatment.

3. The method according to claim 2, wherein the energy beam irradiation treatment includes an ion beam, a laser beam, an electron beam, and/or a cluster beam.

4. The method according to claim 1, wherein the activation treatment includes at least one of exposing the PZT material component to a heat source and exposing the PZT material component to a light source.

5. The method according to claim 1, wherein the activation treatment is conducted every time a component is built into the product.

6. A method for manufacturing a head gimbal assembly incorporating a PZT micro-actuator, the method comprising:
providing a PZT element;
mounting the PZT element to a micro-actuator to provide a PZT micro-actuator;
mounting a slider to the PZT micro-actuator to provide a slider and PZT micro-actuator assembly;
mounting the slider and PZT micro-actuator assembly to a head gimbal assembly;
electrically connecting the slider and PZT micro-actuator assembly to the head gimbal assembly; and
treating the PZT element.

7. The method according to claim 6, wherein treating the PZT element includes at least one of exposing the PZT element to a heat source and exposing the PZT element to a light source.

8. The method according to claim 6, wherein treating the PZT element includes maintaining a temperature within about ±25° C. of a PZT curie temperature.

9. The method according to claim 6, wherein treating the PZT element occurs at at least one of (a) before mounting the PZT element to the micro-actuator, (b) after mounting the PZT element to the micro-actuator, (c) before mounting the slider to the PZT micro-actuator, (d) after mounting the slider to the PZT micro-actuator, (e) before mounting the slider and PZT micro-actuator assembly to the head gimbal assembly, (f) after mounting the slider and PZT micro-actuator assembly to the head gimbal assembly, (g) before electrically connecting the slider and PZT micro-actuator assembly to the head gimbal assembly, and (h) after electrically connecting the slider and PZT micro-actuator assembly to the head gimbal assembly.

10. The method according to claim 6, wherein providing the PZT element includes providing a block of ceramic or thin film PZT.

11. The method according to claim 6, wherein providing the PZT element includes providing single layer or multi-layer PZT.

12. The method according to claim 6, wherein mounting the PZT element to the micro-actuator includes mounting a PZT element to a side arm of the micro-actuator.

13. A head gimbal assembly including a PZT micro-actuator manufactured according to the method of claim 6.

14. A disk drive unit, comprising:
a head gimbal assembly including a PZT micro-actuator manufactured according to the method of claim 6;
a drive arm connected to the head gimbal assembly;
a disk; and
a spindle motor operable to spin the disk.

15. A method for treating a PZT micro-actuator for a head gimbal assembly, the method comprising:
mounting a PZT element to a micro-actuator to provide a PZT micro-actuator; and
treating the PZT element by at least one of exposing the PZT element to a heat source and exposing the PZT element to a light source.

16. The method according to claim 15, wherein treating the PZT element occurs before mounting the PZT element to the micro-actuator.

17. The method according to claim 15, wherein treating the PZT element occurs after mounting the PZT element to the micro-actuator.

18. The method according to claim 15, wherein treating the PZT element includes a first treatment before mounting the PZT element to the micro-actuator and a second treatment after mounting the PZT element to the micro-actuator.

19. The method according to claim 15, wherein treating the PZT element includes maintaining a temperature within about ±25° C. of a PZT curie temperature.

20. A PZT micro-actuator for a head gimbal assembly comprising:
a micro-actuator frame for holding a slider; and
at least one PZT element mounted on the micro-actuator frame, wherein the PZT element has been treated with heat and/or light to improve operation thereof after an annealing process used to manufacture the PZT element.

21. A method for manufacturing a head gimbal assembly incorporating a PZT micro-actuator, the method comprising:
providing a PZT element;
mounting the PZT element to a micro-actuator to provide a PZT micro-actuator;
treating the PZT micro-actuator to provide a treated PZT micro-actuator;
mounting a slider to the treated PZT micro-actuator to provide a slider and treated PZT micro-actuator assembly;
mounting the slider and treated PZT micro-actuator assembly to a head gimbal assembly; and
electrically connecting the slider and treated PZT micro-actuator assembly to the head gimbal assembly.

22. The method according to claim 21, wherein treating the PZT micro-actuator includes at least one of exposing the PZT micro-actuator to a heat source and exposing the PZT micro-actuator to a light source.

23. The method according to claim 21, wherein treating the PZT micro-actuator includes maintaining a temperature within about ±25° C. of a PZT curie temperature.

24. A method for manufacturing a head gimbal assembly incorporating a PZT micro-actuator, the method comprising:
providing a PZT element;
mounting the PZT element to a micro-actuator to provide a PZT micro-actuator;
mounting a slider to the PZT micro-actuator to provide a slider and PZT micro-actuator assembly;
mounting the slider and PZT micro-actuator assembly to a head gimbal assembly;
electrically connecting the slider and PZT micro-actuator assembly to the head gimbal assembly; and
treating the PZT micro-actuator after electrically connecting the slider and PZT micro-actuator assembly to the head gimbal assembly.

25. The method according to claim 24, wherein treating the PZT micro-actuator includes at least one of exposing the PZT micro-actuator to a heat source and exposing the PZT micro-actuator to a light source.

26. The method according to claim 24, wherein treating the PZT micro-actuator includes maintaining a temperature within about ±25° C. of a PZT curie temperature.

27. A method for manufacturing a head gimbal assembly incorporating a PZT micro-actuator, the method comprising:
providing a PZT element;
mounting the PZT element to a micro-actuator to provide a PZT micro-actuator;
treating the PZT micro-actuator in a first treatment;
mounting a slider to the first treated PZT micro-actuator to provide a slider and first treated PZT micro-actuator assembly;
treating the slider and first treated PZT micro-actuator assembly to treat the first treated PZT micro-actuator in a second treatment;
mounting the slider and second treated PZT micro-actuator assembly to a head gimbal assembly;
treating the head gimbal assembly to treat the second treated PZT micro-actuator in a third treatment;
electrically connecting the slider and third treated PZT micro-actuator assembly to the head gimbal assembly; and
treating the head gimbal assembly to treat the third treated PZT micro-actuator in a fourth treatment.

28. The method according to claim 27, wherein treating the PZT micro-actuator, treating the slider and first treated PZT micro-actuator assembly, and treating the head gimbal assembly includes at least one of exposing the PZT micro-actuator to a heat source and exposing the PZT micro-actuator to a light source.

29. The method according to claim 27, wherein treating the PZT micro-actuator, treating the slider and first treated PZT micro-actuator assembly, and treating the head gimbal assembly includes maintaining a temperature within about ±25° C. of a PZT curie temperature.
